(19) United States
(12) Patent Application Publication
(10) Pub. No.: US 2020/0124125 A1
(43) Pub. Date: Apr. 23, 2020

(54) METHOD OF MAKING WET FRICTION MATERIAL WITH WATER BASED PHENOLIC RESIN

(71) Applicant: Schaeffler Technologies AG & Co. KG, Herzogenaurach (DE)

(72) Inventors: Rashid Farahati, Copley, OH (US); Murat Bakan, Wooster, OH (US)

(21) Appl. No.: 16/163,540

(22) Filed: Oct. 17, 2018

(51) Int. Cl. F16D 69/02; F16D 13/64; F16D 69/04; B32B 15/098; B32B 27/20; B32B 27/42; B32B 37/06; B32B 37/10; B32B 37/18; C08L 61/06

(52) U.S. Cl. CPC F16D 69/026; F16D 13/64; F16D 69/0408; B32B 15/098; B32B 27/205; F16H 45/02; B32B 37/06; B32B 37/10; B32B 37/182; C08L 61/06; B32B 27/42

(57) ABSTRACT

A method of making a wet friction material layer includes joining filler particles and fibers together to form a material base; adding water based phenolic resin to the material base; and curing the water based phenolic resin.

The present disclosure relates generally to friction clutches and plates used in torque converters and motor vehicle transmissions and more specifically to wet friction material.

### BACKGROUND

The friction material in wet-type friction clutches generally operates in an oil submerged environment and is often paper-based material used to form friction material rings. It is known to use alcohol based phenolic resins in the wet friction material.

### SUMMARY OF THE INVENTION

A method of making a wet friction material is provided. The method includes joining filler particles and fibers together to form a material base; adding water based phenolic resin to the material base; and curing the water based phenolic resin.

In embodiments of the method, the water based phenolic resin may be a resole. The resole may include phenol as a polymer with formaldehyde, free phenol and free formaldehyde. The resole may include 71 to 76% phenol as a polymer with formaldehyde, 20 to 22% free phenol and 0.1 to 1% free formaldehyde. The resole may have a pH of 7.8 to 8.3. The resole may have a water tolerance % of 270.00 to 330.00. The resole may have a water tolerance % of 300.00. The resole may have a non-volatile % of 70.00 to 80.00. The resole may have a non-volatile % of 74.00. The resole may have a viscosity @ 25° C., cps of 325.00 to 375.00. The resole may have a viscosity @ 25° C., cps of 350.00. The resole may have a relative density of 1.15 to 1.25. The resole may have a relative density of 1.18 to 1.20. The resole may be Varcum 29353 Liquid Phenolic Resin. The wet friction material layer may include greater than 20% by percentage weight aramid fibers.

A method of making a part of a friction clutch is also provided that includes making the wet friction material and fixing the wet friction material layer to a metal part of the friction clutch.

A wet friction material formed by performing the method is also provided. The wet friction material layer may include greater than 20% by percentage weight aramid fibers.

### BRIEF DESCRIPTION OF THE DRAWINGS

The present disclosure is described below by reference to the following drawings, in which:

FIG. 1a schematically shows a wet friction material layer before the water based phenolic resin is added;

FIG. 1b shows an enlarged view of a section of wet friction material layer shown in FIG. 1a illustrating fibers and diatomaceous earth particles;

FIG. 1c shows the wet friction material layer after the water based phenolic resin is added to the wet friction material layer;

FIG. 2 shows the wet friction material layer being joined on top of a metal part via a heat plate; and

FIG. 3 shows a wet friction material layer bonded to both sides of a clutch plate of lockup clutch assembly of a torque converter.

### DETAILED DESCRIPTION

The present disclosure provides a method that forms a wet friction material layer using water based phenolic resin, instead of solvent based phenolic resin. Solvent based phenolic resin can be difficult to obtain and are bad from the environment, but water based phenolic resins are usually not sufficient to provide comparable properties in wet friction materials. In particular, water based phenolic resins are usually not capable of producing wet friction materials of sufficient strength. The reason for the failure of the production of wet friction material layer using water based phenolic resin is mainly because the chemistry of the water based phenolic resin (potentially the presence higher molecular weight compounds) and the high surface tension of water that makes the interior region of the friction materials resin starving. Friction materials delaminate even under much smaller shear forces (lower than 1 MPa, while solvent based resin yields several MPa) because the water based phenolic resin cannot sufficiently penetrate into the wet friction material.

Due to industrial needs for a higher temperature application, the aramid percentage in the materials is being increased from 0 to greater than 20%.

The inventors have discovered, after experimenting with a number of water based phenolic resins, that a resole is capable of producing wet friction materials of sufficient strength. In particular, a resole including phenol as a polymer with formaldehyde, free phenol and free formaldehyde is used to produce wet friction materials of sufficient strength.

In one embodiment, such a resole includes 71 to 76% phenol as a polymer with formaldehyde, 20 to 22% free phenol and 0.1 to 1% free formaldehyde. The resole has a pH of 7.8 to 8.3 (typically 8.05 using test method DCT 4064A), a water tolerance % of 270.00 to 330.00 (using test method DCT 4012A), a non-volatile % of 70.00 to 80.00 (using test method DCT 4005A), a viscosity @ 25° C., cps of 325.00 to 375.00 (using test method DCT 4003F) and a relative density of 1.15 to 1.25.

In one particularly preferred embodiment, the resole includes 71 to 76% phenol as a polymer with formaldehyde, 20 to 22% free phenol and 0.1 to 1% free formaldehyde. The resole has a pH of 7.8 to 8.3 (typically 8.05 using test method DCT 4064A), a water tolerance % of 300.00 (using test method DCT 4012A), a non-volatile % of 74.00 (using test method DCT 4005A), a viscosity @ 25° C., cps of 350.00 (using test method DCT 4003F) and a relative density of 1.18 to 1.20. Such a resole is available from SBHPP, which is a business unit of Sumitomo Bakelite Co., Ltd, sold as Varcum 29353 Liquid Phenolic Resin.

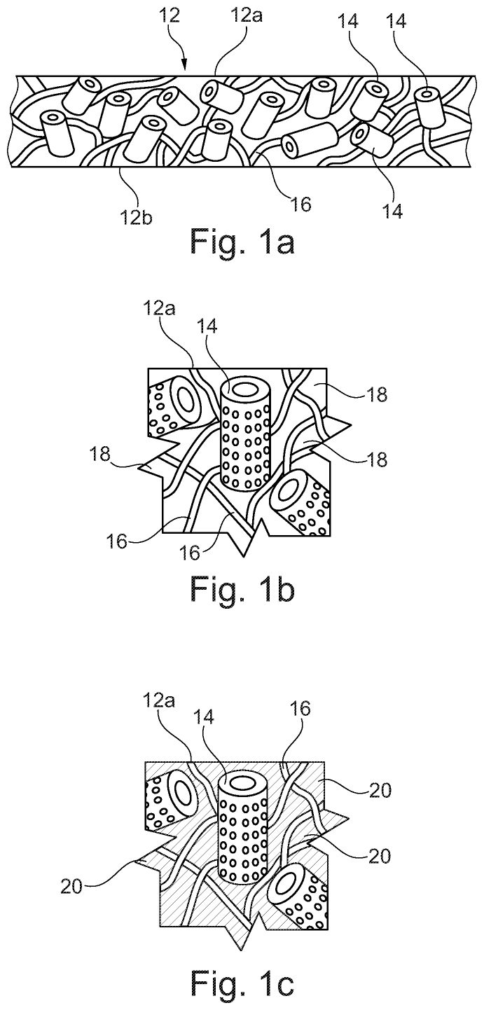

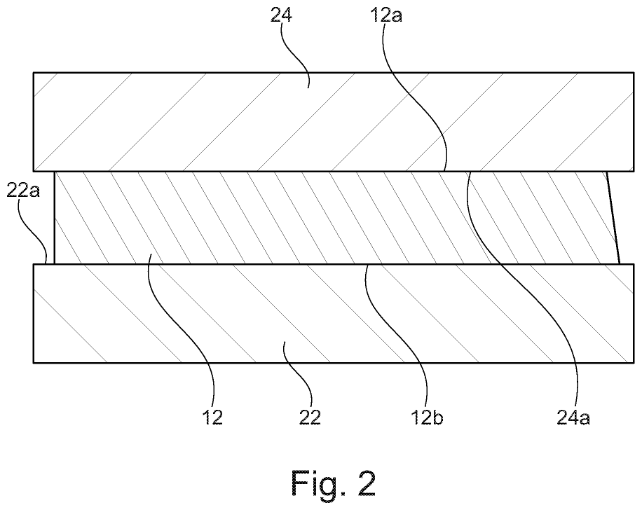

FIGS. 1a to 1c and 2 schematically illustrate a method of forming a wet friction material layer and a clutch assembly in accordance with an embodiment of the present disclosure.

A wet friction material layer 12 is formed of fibers, filler material and a binder. The fibers can be aramid fibers, organic fibers, carbon fibers and/or fiberglass. The organic fibers include cellulose fibers or cotton fibers. The filler material can be particles of diatomaceous earth. The binder is a water based phenolic resin. Optionally a friction modifier such as graphite may also be included in wet friction material layer 12. The fibers of layer 12 have a mean diameter of 45 to 55 microns and a mean length of 1 to 2 millimeters.

In some preferred embodiments, wet friction material layer 12 includes, by percentage weight, 25 to 45% fibers, 25 to 40% filler material, 25 to 40% water based phenolic resin. More specifically, wet friction material layer 12 includes, by percentage weight, 30 to 40% fibers, 30 to 35% filler material, 30 to 35% water based phenolic resin. In particular, the wet friction material layer 12 may advantageous include, by percentage weight, greater than 20% aramid fibers.

FIG. 1a schematically shows wet friction material layer 12 before the water based phenolic resin is added. Wet friction material layer 12 includes a material base formed by fillers in the form of a plurality of diatomaceous earth particles 14 imbedded in a matrix of fibers 16 between a first outer surface 12a and a second outer surface 12b of wet friction material layer 12.

FIG. 1b shows an enlarged view of wet friction material layer 12 shown in FIG. 1a, illustrating a section of wet friction material layer 12 including fibers 16 and diatomaceous earth particles 14 joined together. Fibers 16 and particles 14 are joined together in a pulping process, which involves forming a mixture of the fibers 16 and particles 14 submerged together in a liquid, then drying the mixture to remove the liquid. After fibers 16 and particles 14 are joined together, wet friction material layer 12 includes a matrix formed by fibers 16 and diatomaceous earth particles 14, that includes a network of voids 18.

As shown in FIG. 1c, after fibers 16 and particles 14 are joined together, the water based phenolic resin 20 is added to wet friction material layer 12. The water based phenolic resin penetrates past outer surface 12a into an interior of the wet friction material layer 12 such that voids 18 in the interior of wet friction material layer 12 are saturated with the water based phenolic resin 20.

As shown in FIG. 2, wet friction material layer 12 is then placed on top of a metal part 22 and layer 12 and part 22 are joined together to form a friction assembly. The joining of layer 12 and part 22 together includes pressing wet friction material layer 12 against metal part 22 with a heat plate 24 to cure the water based phenolic resin 20 in wet friction material layer 12, fixing wet friction material layer 12 and metal part 22 together. The force of pressing of heat plate 24 against outer surface 12a of wet friction material layer 12, while inner surface 12b of wet friction material layer 12 rests on an outer layer 22a of metal part 22, causes the phenolic resin to accumulate at an interface of inner surface 12b of wet friction material layer 12 and outer surface 22a of metal part 22, while the curing of the water based phenolic resin by the heat of heat plate 24 creates a permanent connection between metal part 22 and wet friction material layer 12. Water based phenolic resin 20 shown in FIG. 1c solidifies and hardens in wet friction material layer 12 to fix fibers 16 and particles 14 in place. In one preferred embodiment, the heat at a surface 24a of plate 24 that contacts outer surface 12a of outer layer is 375 to 425 degrees F.

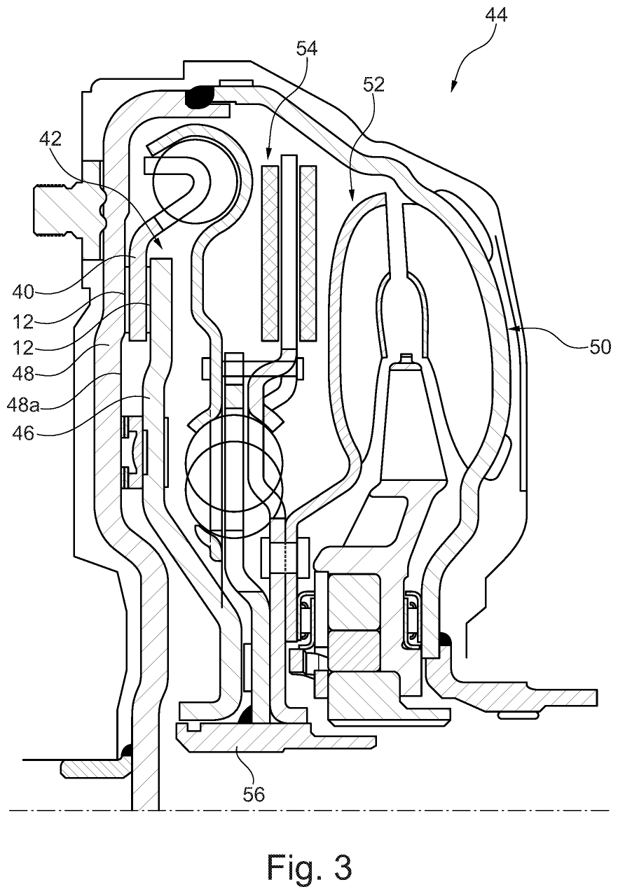

FIG. 3 shows wet friction material layer 12 bonded to both sides of a metal part in the form of a clutch plate 40 of lockup clutch assembly 42 of a torque converter 44. A piston 46 of lockup clutch assembly 42 forces clutch plate 40 against an inside surface 48a of a front cover 48 of torque converter 44. Piston 46 contacts the surface 12a of the rear piece of wet friction material 42 to force the surface 12a on the front piece of wet friction material layer 12 against inside surface 48a of front cover 48. The forcing of clutch plate 40 against front cover 48 by piston 46 locks the lockup clutch assembly 42 such that a torque path in torque converter 44 to a transmission input shaft bypasses an impeller 50 and a turbine 52 of torque converter 44, and instead flows from front cover 48 to clutch plate 40 and through a damper assembly 54 to a transmission input shaft that is connected to an output hub 56 of torque converter 44.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

12 wet friction material layer
12a outer surface
12b inner surface
14 diatomaceous earth particles
16 fibers
18 voids
20 water based phenolic resin
22 metal part
22a outer surface
24 heat plate
24a surface
40 clutch plate
42 lockup clutch assembly
44 torque converter
46 piston
438 front cover
48a inside surface
50 impeller
52 turbine
54 damper assembly
56 output hub

What is claimed is:

1. A method of making a wet friction material layer comprising:
joining filler particles and fibers together to form a material base;
adding water based phenolic resin to the material base; and
curing the water based phenolic resin.

2. The method as recited in claim 1 wherein the water based phenolic resin is a resole.

3. The method as recited in claim 2 wherein the resole includes phenol as a polymer with formaldehyde, free phenol and free formaldehyde.

4. The method as recited in claim 3 wherein the resole includes 71 to 76% phenol as a polymer with formaldehyde, 20 to 22% free phenol and 0.1 to 1% free formaldehyde.

5. The method as recited in claim 3 wherein the resole has a pH of 7.8 to 8.3.

6. The method as recited in claim 3 wherein the resole has a water tolerance % of 270.00 to 330.00.

7. The method as recited in claim 6 wherein the resole has a water tolerance % of to 300.00.

8. The method as recited in claim 3 wherein the resole has a non-volatile % of 70.00 to 80.00.

9. The method as recited in claim 8 wherein the resole has a non-volatile % of 74.00.

10. The method as recited in claim 3 wherein the resole has a viscosity @ 25° C., cps of 325.00 to 375.00.

11. The method as recited in claim 10 wherein the resole has a viscosity @ 25° C., cps of 350.00.

12. The method as recited in claim 3 wherein the resole has a relative density of 1.15 to 1.25.

13. The method as recited in claim 12 wherein the resole has a relative density of 1.18 to 1.20.

14. The method as recited in claim 3 wherein the resole is Varcum 29353 Liquid Phenolic Resin.

15. The method as recited in claim 1 wherein the wet friction material layer includes greater than 20% by percentage weight aramid fibers.

16. A method of making a part of a friction clutch comprising:
making the wet friction material with the method as recited in claim 1; and
fixing the wet friction material layer to a metal part of the friction clutch.

17. A wet friction material formed by performing the method as recited in claim 1.

18. The wet friction material as recited in claim 17 wherein the wet friction material layer includes greater than 20% by percentage weight aramid fibers.
